(19) United States
(12) Patent Application Publication
(10) Pub. No.: US 2026/0208819 A1
(43) Pub. Date: Jul. 23, 2026

(54) SWITCHING SYSTEM

(71) Applicant: Brembo S.p.A., Curno, Bergamo (IT)

(72) Inventors: Alessandro ESPOSITO, Curno, Bergamo (IT); Gianni BELLOLI, Curno, Bergamo (IT)

(21) Appl. No.: 19/140,421

(22) PCT Filed: Dec. 20, 2023
(86) PCT No.: PCT/IB2023/063033

§ 371 Date: Jun. 18, 2025

(30) Foreign Application Priority Data
Dec. 22, 2022 (IT) 102022000026511

(51) Int. Cl. B62L 3/02; B62K 23/06; G05G 1/04; H01H 21/28

(52) U.S. Cl. CPC B62L 3/023; B62K 23/06; G05G 1/04; H01H 21/28

(57) ABSTRACT

A switching system (1), in particular installable on a motorcycle for alternately activating a plurality of electrical circuits of the motorcycle, comprising a switch (2), comprising a switch lever (3) and a switch body (4), wherein the switch lever (3) is constrained to the switch body (4), said switch (1) further comprising a first electric circuit (5) and a second electric circuit (6) alternately activatable based on the position of the switch lever (3), an actuating member (7), configured to actuate the switch (2), a connecting mechanism (8), interposed between the actuating member (7) and the switch (2), and configured to connect the actuating member (7) to the switch lever (3), so that a movement of the actuating member (7) corresponds to a movement of the switch lever (3).

### FIELD OF THE INVENTION

The present invention relates to a switching system, in particular a switching system adapted to be installed on a motorcycle, moped and the like, for alternately activating a plurality of electrical circuits of the motorcycle.

### BACKGROUND ART

Motorcycles of the prior art comprise switching systems comprising a plurality of switches for activating and deactivating respective electrical circuits linked to certain functions of the motorcycles.

In particular, it is known to equip a motorcycle with a switch for opening and closing a first electrical circuit which, for example, controls a “cruise control” function, and a further switch for opening and closing a second electrical circuit which, for example, controls the activation of the motorcycle engine start enabling function. This plurality of switches is generally positioned at the brake and clutch lever of the motorcycle.

It is also known to configure the switch linked to the “cruise control” function so as to close the respective electrical circuit when the switch is in the resting position. The “cruise control” function is thus kept active without requiring any intervention by the user.

Moreover, it is known to configure the switch linked to the motorcycle engine start enabling function so as to open the respective electrical circuit when the switch is positioned in the resting position. An intervention by the user is thus required in order to activate the motorcycle start enabling function, otherwise deactivated when the respective switch is in the resting position.

Such known communication systems comprising a plurality of switches dedicated to respective electrical circuits are particularly complex to manufacture and install on the motorcycle, and thus require long processing and installation times, as well as high maintenance.

### SOLUTION

It is the object of the present invention to provide a switching system having features such as to obviate at least some of the drawbacks noticed in the prior art.

It is a particular object of the present invention to provide a simplified switching system such as to require reduced processing and assembly times compared to known switching systems, as well as a lower need for maintenance.

These and other objects are achieved by a switching system according to claim 1.

The dependent claims relate to preferred and advantageous embodiments of the present invention.

### DRAWINGS

In order to better understand the invention and appreciate the advantages thereof, some non-limiting exemplary embodiments thereof will be described below with reference to the accompanying drawings, in which:

FIG. 1 is a perspective view of a switching system according to the prior art;

FIG. 2 is a detailed view of the switching system depicted in FIG. 1;

FIG. 3 is a perspective view of a switching system, according to an embodiment of the invention;

FIG. 4 is a front view of the switching system depicted in FIG. 3;

FIG. 5 is an upper perspective view of the switching system depicted in FIG. 3;

FIG. 6 is a perspective view of a switching system, according to an embodiment of the invention;

FIG. 7A is a diagrammatic depiction of a component of a switching system, according to an embodiment of the invention, in a first operating configuration;

FIG. 7B is a further diagrammatic depiction of a component of a switching system, in a second operating configuration;

FIG. 7C is a further diagrammatic depiction of a component of a switching system, in a third operating configuration;

FIG. 8 is a detailed view of a switching system, showing visible and non-visible details, according to an embodiment, in a first operating configuration;

FIG. 9 is a detailed view of the switching system depicted in FIG. 8, showing visible and non-visible details, in a second operating configuration;

FIG. 10 is a detailed view of the switching system depicted in FIG. 8, showing visible and non-visible details, in a third operating configuration;

FIG. 11 is a longitudinal section view of a component of a switching system, according to an embodiment, in a first operating configuration;

FIG. 12 is a longitudinal section view of the component depicted in FIG. 11, in a second operating configuration;

FIG. 13 is a longitudinal section view of the component depicted in FIG. 11, in a third operating configuration;

FIG. 14 is an exploded view of a component of a switching system, according to an embodiment of the invention.

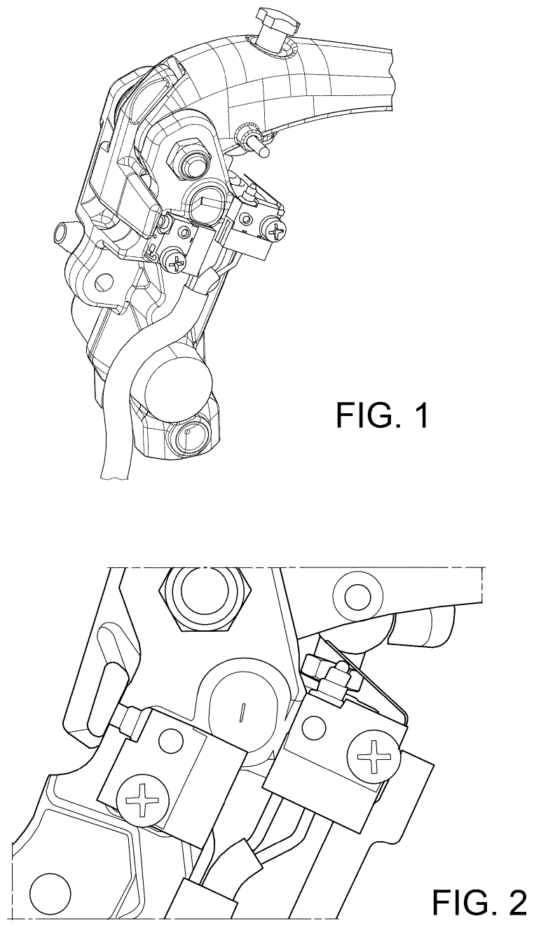

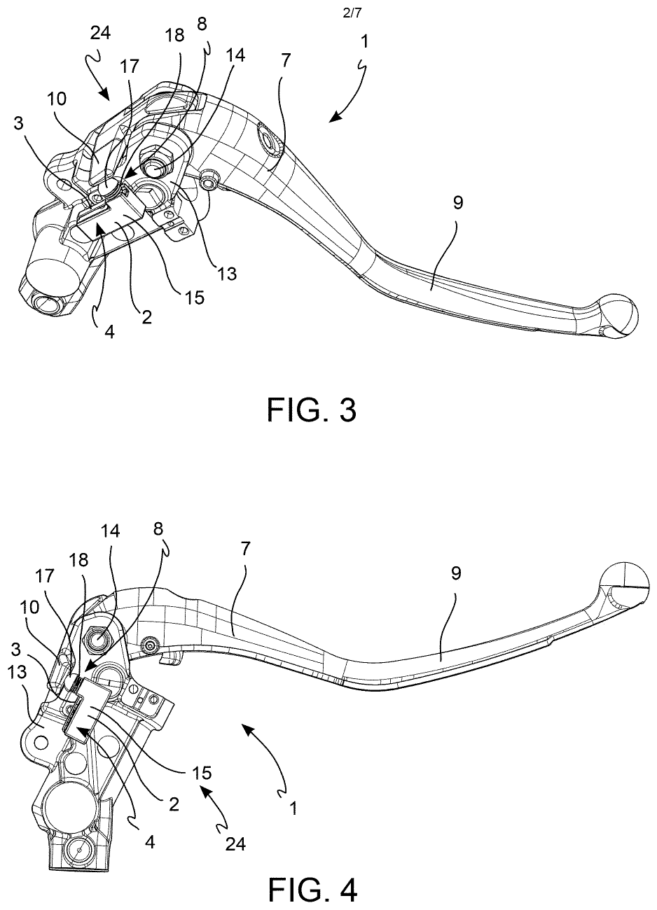

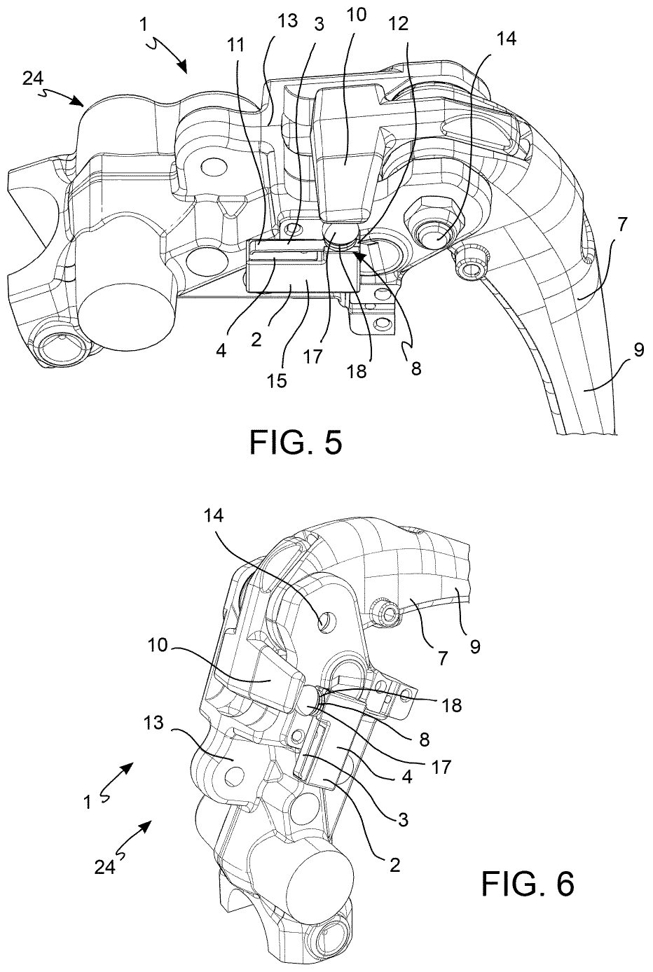

### DESCRIPTION OF SOME PREFERRED EMBODIMENTS

With reference to the figures, a switching system is generally indicated by reference numeral 1.

The switching system 1 is particularly adapted to be installed on a motorcycle, a moped and the like, for alternately activating a plurality of electrical circuits of the motorcycle.

The switching system 1 comprises a switch 2.

The switch 2 comprises a switch lever 3 and a switch body 4.

The switch lever 3 is constrained to the switch body 4.

Moreover, the switch 2 comprises a first electrical circuit 5 and a second electrical circuit 6.

The first electrical circuit 5 and the second electrical circuit 6 are alternately activatable based on the position of the switch lever 3. Therefore, the position of the switch lever 3 causes the activation of the first electrical circuit 5 or the activation of the second electrical circuit 6.

The switching system 1 further comprises an actuating member 7.

The actuating member 7 is configured to actuate the switch 2. Specifically, the actuating member 7 is configured to actuate the switch lever 3 of the switch 2.

Moreover, the switching system 1 comprises a connecting mechanism 8.

The connecting mechanism 8 is interposed between the actuating member 7 and the switch 2, and is configured to connect the actuating member 7 to the switch lever 3 of the switch 2, so that a movement of the actuating member 7 corresponds to a movement of the switch lever 3.

Advantageously, a switching system 1 thus configured is simplified compared to the prior art and requires reduced processing and assembly times compared to the prior art.

In fact, a switching system 1 thus configured allows alternatively activating two different electrical circuits 5, 6 by a single switch 2 and a single actuating member 7, thus avoiding the presence of two distinct switches, each of which connected to a respective electrical circuit.

With further advantage, the switching system 1 thus configured allows eliminating a switch which opens the respective circuit in the resting position, and thus avoiding extra-stroke problems in case of an incorrect movement of a brake master cylinder not fixed to the handlebar of the motorcycle.

According to an embodiment, the switch 2 is a microswitch.

According to an embodiment, the switch lever 3 is made of stainless steel.

According to an embodiment, the actuating member 7 comprises a gripping portion 9 and an actuating portion 10.

The gripping portion 9 is grippable by a user to actuate the actuating member 7, and the actuating portion 10 is connected to the connecting mechanism 8 and is configured to move the switch lever 3.

According to an embodiment, the actuating member 7 is a lever of the motorcycle. According to an embodiment, the actuating member 7 is a brake lever of the motorcycle. Preferably, the actuating member 7 is the brake lever to be manually actuatable by the user, i.e., the front brake lever of the motorcycle. According to a further embodiment, the actuating member 7 is the clutch lever of the motorcycle.

According to an embodiment, the actuating portion 10 is a vane of a hub of a brake master cylinder of a motorcycle.

Advantageously, a switching system 1 thus configured is improved and simplified compared to the prior art, since the two electrical circuits 5, 6 are alternatively activatable by operating the actuating member 7, i.e., the brake lever of the motorcycle.

According to an embodiment, the switch lever 3 comprises a first lever end 11 and an opposite second lever end 12.

The first lever end 11 is constrained to the switch body 4, while the second lever end 12 is free.

The switch lever 3 is rotatable with respect to the switch body 4, around the first lever end 11.

According to this embodiment, the actuating member 7, by means of the connecting mechanism 8, is configured to act on the second lever end 12, so as to move the switch lever 3 to rotate around the first lever end 11.

According to an embodiment, the switch lever 3 is configured to take at least a first operating position, a second operating position, and a third operating position. The first operating position does not coincide with the second nor with the third operating position, and the second operating position does not coincide with the third operating position.

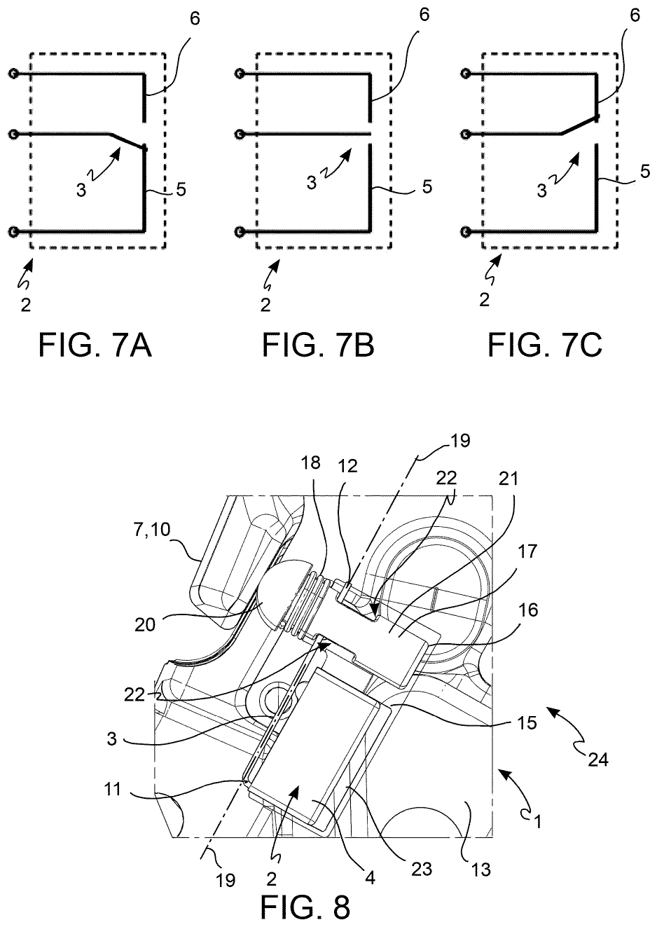

The switch 2 is configured so that when the switch lever 3 is in the first operating position, the first electric circuit 5 is closed and the second electric circuit 6 is open (FIGS. 7A, 8, 11).

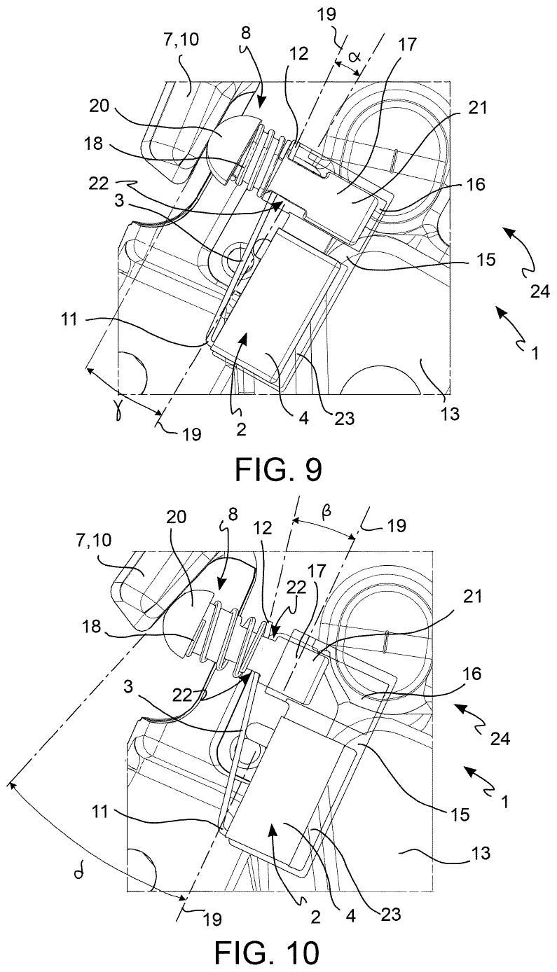

Moreover, the switch 2 is configured so that when the switch lever 3 is in the second operating position, both the first electric circuit 5 and the second electric circuit 6 are open (FIGS. 7B, 9, 12).

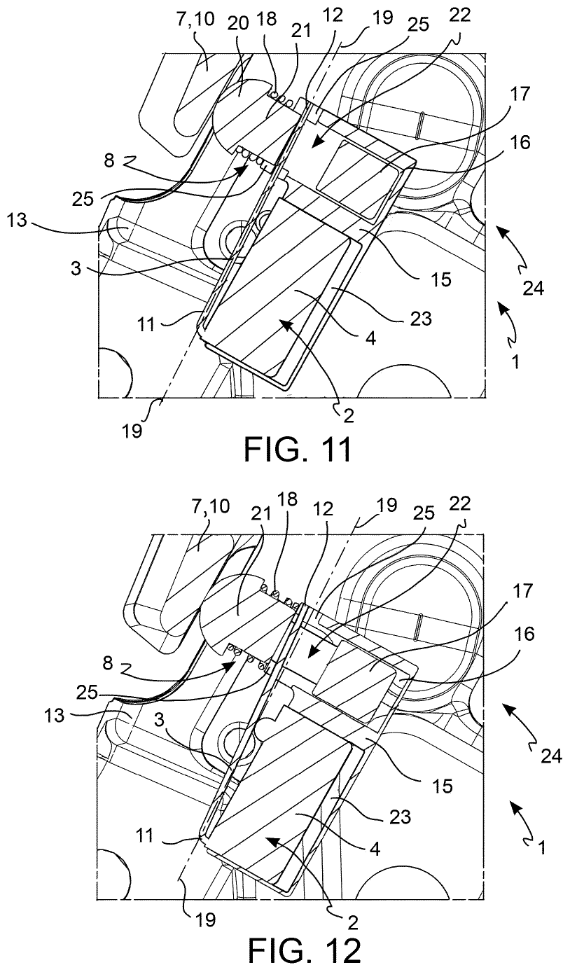

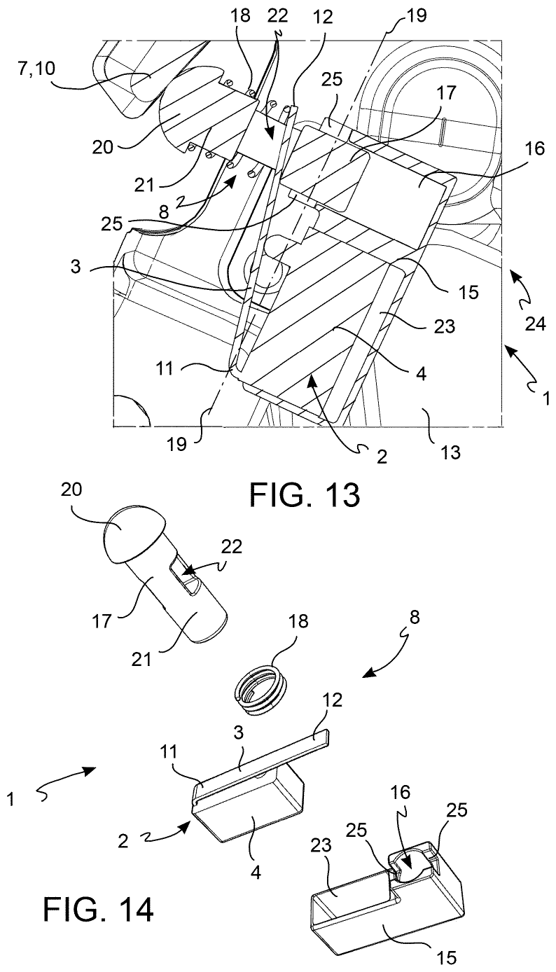

Moreover, the switch 2 is configured so that when the switch lever 3 is in the third operating position, the first electric circuit 5 is open and the second electric circuit 6 is closed (FIGS. 7C, 10, 13).

According to an embodiment, the first operating position corresponds to the resting position of the switch lever 3. Resting position means the position taken by the switch lever 3 in the absence of external biases.

According to an embodiment, the switch lever 3 defines a switch plane 19 transverse to the movement direction of the switch lever 3, in particular to the movement direction of the free end 12 of the switch lever 3. Moreover, the switch lever 3 extends on the switch plane 19 when it is positioned in the first operating position.

According to an embodiment, the switching from the first operating position to the second operating position occurs by means of a rotation of the switch lever 3 by a first angle α with respect to the switch plane 19.

Moreover, the switching from the first operating position to the third operating position occurs by means of a rotation of the switch lever 3 by a second angle β with respect to the switch plane 19.

According to an embodiment, the first angle α is smaller than the second angle β. Therefore, the second operating position is intermediate between the first operating position and the third operating position.

According to an embodiment, the switching system 1 comprises a frame 13.

The actuating member 7 is rotatably connected to the frame 13. Specifically, the actuating member 7 is hinged to the frame 13 by means of a hinge 14.

Therefore, the actuating member 7 is rotatable with respect to the frame 13 around the hinge 14.

Preferably, the hinge 14 is interposed between the gripping portion 9 and the actuating portion 10 of the actuating member 7.

Moreover, the switch body 4 is fixed to the frame 13. Therefore, the switch body 4 is not rotatable with respect to the frame 13, and the switch lever 3 is rotatable with respect to the frame 13 around the first lever end 11.

According to an embodiment, the actuating member 7 is configured to take at least a first angular position, a second angular position, and a third angular position. The first angular position does not coincide with the second nor with the third angular position, and the second angular position does not coincide with the third angular position.

The connecting mechanism 8 is configured so that when the actuating member 7 takes the first angular position, the switch lever 3 takes the first operating position.

Moreover, the connecting mechanism 8 is configured so that when the actuating member 7 takes the second angular position, the switch lever 3 takes the second operating position.

Moreover, the connecting mechanism 8 is configured so that when the actuating member 7 takes the third angular position, the switch lever 3 takes the third operating position.

According to an embodiment, the first angular position corresponds to the resting position of the actuating member 7. Resting position means the position taken by the actuating member 7 in the absence of bias by a user.

According to an embodiment, the switching from the first angular position to the second angular position occurs by means of a rotation of the actuating member 7 by a third angle γ with respect to the switch plane 19.

Moreover, the switching from the first angular position to the third angular position occurs by means of a rotation of the actuating member 7 by a fourth angle δ with respect to the switch plane 19.

According to an embodiment, the third angle α is smaller than the fourth angle β.

Therefore, to switch from the first angular position to the second angular position, it is necessary that the user actuates the actuating member 7, for example by pressing the brake lever. Moreover, the switching from the second angular position to the third angular position requires further actuation of the actuating member 7, for example further pressing the brake lever.

According to an embodiment, the switching system 1 is configured so that, when the actuating member 7 is in the first angular position, the connecting mechanism 8 is configured to bias the switch lever 3 to the first operating position.

Therefore, when the actuating member 7 is in the resting position, the connecting mechanism 8 biases the switch lever 3 to the first operating position.

Therefore, the resting position of the switching system 1, i.e., the configuration taken by the switching system 1 in the absence of external biases by a user, corresponds to the configuration in which the actuating lever 7 is in its resting position, i.e., the first angular position, and the switching lever 3 is in its resting position, i.e., it is in the first operating position.

Advantageously, a switching system 1 thus configured allows keeping the first electrical circuit 5 closed, thus maintaining activated the function controlled by the first electrical circuit 5, and keeping the second electrical circuit 6 open, thus maintaining deactivated the function controlled by the second electrical circuit 6, without the need for external biases by the user, since the switching system 1 is in the resting position. Vice versa, the switching system 1 is configured to require an action by the user to deactivate the function controlled by the first electrical circuit 5 and possibly activate the function controlled by the second electrical circuit 6, since the opening of the first electrical circuit 5 and the possible closing of the second electrical circuit 6 require to move the switching system 1 from the resting position.

According to an advantageous embodiment, the first electrical circuit 5 is configured to control a travel speed adjustment function or “cruise control” of the motorcycle. Moreover, the second electrical circuit 6 is configured to control a motorcycle engine start enabling function.

Advantageously, a switching system 1 thus configured allows keeping the first electrical circuit 5 closed, thus maintaining activated the “cruise control” function, and keeping the second electrical circuit 6 open, thus maintaining deactivated the start enabling function, without the need for external biases by the user, since the switching system 1 is in the resting position. Vice versa, the switching system 1 is configured to require an action by the user to deactivate the “cruise control” function and possibly activate the start enabling function, since the opening of the first electrical circuit 5 and the possible closing of the second electrical circuit 6 require to move the switching system 1 from the resting position.

According to an embodiment, the connecting mechanism 8 comprises a housing 15. According to a preferred embodiment, the housing 15 is made of polybutylene terephthalate (PBT).

The housing 15 defines a first housing seat 16. The first housing seat 16 is open towards the actuating member 7. Specifically, the first housing seat 16 is open towards the actuating portion 10 of the actuating member 7.

Moreover, the connecting mechanism 8 comprises a guide piston 17.

The guide piston 17 is at least partially inserted into the first housing seat 16. Moreover, the guide piston 17 slides within the first housing seat 16. In particular, the guide piston 17 is translatable within the first housing seat 16, with respect to the housing 15.

According to an embodiment, the guide piston 17 can slide and translate within the first housing seat 16 along a direction transverse to the switch plane 19.

The guide piston 17 is connected to the switch lever 3 so that a translation of the guide piston 17 with respect to the housing 15 corresponds to a movement of the switch lever 3.

In particular, the guide piston 17 is connected to the second end 12 of the switching lever 3.

Moreover, the connecting mechanism 8 comprises at least one elastic element 18.

The elastic element 18 is configured to bias the guide piston 17 into abutment against the actuating member 7. Specifically, the elastic element 18 is configured to bias the guide piston 17 against the actuating portion 10 of the actuating member 7.

Advantageously, a switching system 1 thus configured is simplified. Moreover, a connecting mechanism 8 thus configured makes the movement of the switch lever 3 and thus the actuation of the switch 2 by means of the actuating member 7 reversible, sine the guide piston 17, to which the switch lever 3 is connected, remains abutting against the actuating member 7 by the at least one elastic element 18.

According to an embodiment, the actuating member 7 is elastically biased to the resting position through biasing means. The elastic bias applied on the actuating member 7 by the elastic biasing means is greater than the force applied by the at least one elastic element 18 to the guide piston 17 which biases the guide piston 17 to abut against the actuating member 7. Advantageously, such a configuration allows keeping the actuating member 7 in the first angular position when the user does not actuate the actuating member 7.

According to an embodiment, the elastic element 18 is interposed between the housing 15 and the guide piston 17, and is configured to bias the guide piston 17 to exit from the first housing seat 16.

According to an embodiment, the at least one elastic element 18 is a preferably cylindrical, helical compression spring. Preferably, the helical compression spring is positioned substantially coaxial to the guide piston 17.

According to an embodiment, the at least one elastic element 18 is a disc spring or a square spring or a torsion spring or a flat spring or a shaped spring.

According to an embodiment, the guide piston 17 comprises a thrust wall 20.

The thrust wall 20 abuts against the actuating member 7. Specifically, the thrust wall 20 abuts against the actuating portion 10 of the actuating member 7.

Moreover, the guide piston 17 comprises a rod 21. The rod 21 is connected to the thrust wall 20 and extends from the thrust wall 20 in the direction opposite to the actuating member 7.

The rod 21 extends at least partially into the first housing seat 16.

According to an embodiment, the thrust wall 20 is positioned outside the housing 15.

According to an embodiment, the thrust wall 20 has a convex shape facing the actuating member 7.

Preferably, the thrust wall 20 is in the shape of a sphere portion, preferably a half-sphere, where the sphere portion wall abuts against the actuating member 7.

According to an embodiment, the rod 21 is substantially cylindrical in shape, extending about an axis transverse to the switch plane 19.

Preferably, the thrust wall 20 is coaxial to the rod 21.

Preferably, the thrust wall 20 has a greater section, along the switch plane 19, than a section of the rod 21 along the switch plane 19.

According to an embodiment, the at least one elastic element 18 is interposed between the thrust wall 20 and the housing 15. Preferably, the at least one elastic element 18 is further wound around the rod 21.

According to an embodiment, the guide piston 17 is made of fiber-reinforced plastic and graphite. Advantageously, such a configuration reduces the wear on the guide piston 17 and the friction generated by the relative movement between the actuating member 7 and the guide piston 17 abutting against the actuating member 7.

According to an embodiment, the guide piston 17 defines a coupling opening 22.

According to this embodiment, the switch lever 3 is inserted into the coupling opening 22. Specifically, the second end 12 of the switch lever 3 is inserted into the coupling opening 22.

Advantageously, through this geometric connection between the switch lever 3 and the guide piston 17, the switch lever 3 is movable by the guide piston 17 upon a movement of the actuating member 7.

The coupling opening 22 faces the switch lever 3.

According to an embodiment, the coupling opening 22 passes through the rod 21 of the guide piston 17.

According to an embodiment, the switch lever 3 extends through the coupling opening 22. Preferably, the second end 12 of the switch lever 3 extends beyond the coupling opening 22. Therefore, the second end 12 of the switch lever 3 extends beyond the rod 21 of the guide piston 17.

Advantageously, such a configuration ensures a guided and accurate movement of the switch lever 3, by the connection mechanism 8, as a function of a movement of the actuating member 7.

According to an embodiment, the switching system 1 is configured so that, when the actuating member 7 is in the first angular position, i.e., the resting position of the actuating member 7, the coupling opening 22 is covered by the housing 15. In such a configuration, the switch lever 3 inserted into the coupling opening 22 is biased to the first operating position by means of the guide piston 17. Moreover, in such a configuration, the switch lever 3 is not in contact with the at least one elastic element 18 interposed between the housing 15 and the guide piston 17.

The switching system 1 is further configured so that, when the actuating member 7 is in the second angular position, the coupling opening 22 is at least partially uncovered by the housing 15. In such a configuration, the switch lever 3 is in contact with the at least one elastic element 18, and the switch lever 3 inserted into the coupling opening 22 is biased to the second operating position by means of the biasing action of the at least one elastic element 18.

The switching system 1 is further configured so that, when the actuating member 7 is in the third angular position, the coupling opening 22 is at least partially uncovered, preferably totally uncovered, by the housing 15. In such a configuration, the switch lever 3 is in contact with the at least one elastic element 18, and the switch lever 3 inserted into the coupling opening 22 is biased to the third operating position by means of the biasing action of the at least one elastic element 18. Preferably, in this configuration, the at least one elastic element 18 is operatively maintained under compression by the switch lever 3 and the guide piston 17, so as to preserve an elastic bias against the switch lever 3 and the guide piston 17.

Advantageously, the combined action of the guide piston 17 and the elastic element 18 ensures a guided and accurate movement of the switch lever 3.

With further advantage, a connecting mechanism 8 thus configured is more adjustable and customizable, since it allows adjusting and changing the ratio between the first and second angles α and β covered by the switch lever 3, and the corresponding third and fourth angles γ and δ covered by the actuating member 7. In fact, since the at least one elastic element 18 is in contact with the actuating member 7 and the switching lever 3, an elastic element 18 having a different elastic constant can ensure a different degree of rotation of the actuating member 7 with respect to the same degree of rotation of the switch lever 3. Therefore, certain values of the first and second angles α and β covered by the switch lever 3 can correspond to different values of the third and fourth angles γ and δ covered by the actuating member 7, by changing the elastic constant of the elastic element 18.

According to an embodiment, the coupling opening 22 extends in a direction parallel to the rod 21, i.e., along a direction transverse to the switch plane 19. Advantageously, such a configuration allows obtaining a sliding coupling between the switch lever 3 and the guide piston 17, during the movement of the switch lever 3.

According to an embodiment, the housing 15 defines a groove 25 facing the coupling opening 22 and open towards the actuating member 7. Advantageously, such a configuration allows obtaining a sliding coupling between the switch lever 3, the guide piston 17, and the housing 15, and allows the switch lever 3 to exit from the housing 15, during the movement of the switch lever 3.

According to an alternative embodiment, the at least one elastic element 18 is interposed between the guide piston 17 and the switch lever 3. Specifically, the opposite ends of the elastic element 18 abut against the guide piston 17 and the switch lever 3, respectively. Preferably, the at least one elastic element 18 is interposed between the thrust wall 20 and the switch lever 3. According to this alternative embodiment, the switching system 1 is configured so that the at least one elastic element 18 is in contact with the switch lever 3, and biases the switch lever 3, when the switch lever 3 is in the first operating position, and in the second operating position, and in the third operating position.

According to a further alternative embodiment, the connecting mechanism 8 comprises an articulated connecting mechanism, interposed between the actuating member 7 and the switch lever 3. The articulated connecting mechanism is configured to connect the actuating member 7 to the switch lever 3, so that a movement of the actuating member 7 corresponds to a movement of the switch lever 3.

According to a further alternative embodiment, the connecting mechanism 8 comprises a cam element, interposed between the actuating member 7 and the switch lever 3. The cam element is configured to connect the actuating member 7 to the switch lever 3, so that a movement of the actuating member 7 corresponds to a movement of the switch lever 3.

According to an embodiment, the housing 15 defines a second housing seat 23. Preferably, the second housing seat 23 is open towards the actuating member 7. The switch body 4 is housed within the second housing seat 23.

According to a further aspect of the invention, a braking system 24, in particular for a motorcycle, moped or the like, comprises a brake lever operatively connected to a brake master cylinder.

Moreover, the braking system 24 comprises a switching system 1 as previously described.

Moreover, the brake lever of the braking system 24 is the actuating member 7 of the switching system 1.

According to an embodiment, the actuating portion 10 is a vane of a hub of the brake master cylinder of the braking system 24.

According to a further aspect of the invention, a clutch system, in particular for a motorcycle, moped or the like, comprises a clutch lever.

Moreover, the clutch system comprises a switching system 1 as previously described.

Moreover, the clutch lever of the clutch system is the actuating member 7 of the switching system 1.

Obviously, those skilled in the art will be able to make changes or adaptations to the present invention, without however departing from the scope of the following claims.

### LIST OF REFERENCE SIGNS

1. Switching system
2. Switch
3. Switch lever
4. Switch body
5. First electrical circuit
6. Second electrical circuit
7. Actuating member
8. Connecting mechanism
9. Gripping portion
10. Actuating portion
11. First lever end
12. Second lever end
13. Frame
14. Hinge
15. Housing
16. First housing seat
17. Guide piston
18. Elastic element
19. Switch plane
20. Thrust wall
21. Rod
22. Coupling opening
23. Second housing seat
24. Braking system
25. Groove
α. First angle
β. Second angle
γ. Third angle
δ. Fourth angle

1-16. (canceled)

17. A switching system (1), in particular installable on a motorcycle for alternately activating a plurality of electrical circuits of the motorcycle, comprising:
a switch (2), comprising a switch lever (3) and a switch body (4), wherein the switch lever (3) is constrained to the switch body (4), said switch (1) further comprising a first electric circuit (5) and a second electric circuit (6) alternately activatable based on the position of the switch lever (3),
an actuating member (7), configured to actuate the switch (2),
a connecting mechanism (8), interposed between the actuating member (7) and the switch (2), and configured to connect the actuating member (7) to the switch lever (3), so that a movement of the actuating member (7) corresponds to a movement of the switch lever (3).

18. A switching system (1) according to claim 17, wherein the actuating member (7) comprises a gripping portion (9) and an actuating portion (10), wherein the gripping portion (9) is grippable by a user to actuate the actuating member (7), and the actuating portion (10) is connected to the connecting mechanism (8) and is configured to move the switch lever (3),
wherein the actuating member (7) is preferably a brake lever of a motorcycle, and/or the actuating portion (10) is a vane of a hub of the brake master cylinder of a motorcycle.

19. A switching system (1) according to claim 17, wherein the switch lever (3) comprises a first lever end (11) and an opposite second lever end (12), wherein the first lever end (11) is constrained to the switch body (4), and the second lever end (12) is free, wherein the switch lever (3) is rotatable with respect to the switch body (4), around the first lever end (11),
wherein the actuating member (7) is configured to act on the second lever end (12), by means of the connecting mechanism (8), so as to move the switch lever (3) to rotate around the first lever end (11).

20. A switching system (1) according to claim 17, wherein the switch lever (3) is configured to take at least a first operating position, a second operating position, and a third operating position,
wherein the switch (2) is configured so that:
when the switch lever (3) is in the first operating position, the first electric circuit (5) is closed and the second electric circuit (6) is open;
when the switch lever (3) is in the second operating position, both the first electric circuit (5) and the second electric circuit (6) are open;
when the switch lever (3) is in the third operating position, the first electric circuit (5) is open and the second electric circuit (6) is closed,
and wherein, optionally, the first operating position corresponds to the resting position of the switch lever (3).

21. A switching system according to claim 20, wherein the switch lever (3) defines a switch plane (19) transverse to the movement direction of the switch lever (3), and wherein the switch lever (3) extends on the switch plane (19) when it is positioned in the first operating position,
wherein the switching from the first operating position to the second operating position occurs by means of a rotation of the switch lever (3) by a first angle (α) with respect to the switch plane (19),
wherein the switching from the first operating position to the third operating position occurs by means of a rotation of the switch lever (3) by a second angle (β) with respect to the switch plane (19),
and wherein the first angle (α) is smaller than the second angle (β).

22. A switching system (1) according to claim 20, comprising a frame (13), wherein the actuating member (7) is rotatably connected to the frame (13), preferably wherein the actuating member (7) is hinged to the frame (13) by means of a hinge (14),
wherein the switch body (4) is fixed to the frame (13),
wherein the actuating member (7) is configured to take at least a first angular position, a second angular position, and a third angular position,
wherein the connecting mechanism (8) is configured so that:
when the actuating member (7) takes the first angular position, the switch lever (3) takes the first operating position;
when the actuating member (7) takes the second angular position, the switch lever (3) takes the second operating position;
when the actuating member (7) takes the third angular position, the switch lever (3) takes the third operating position,
and wherein, optionally, the first angular position corresponds to the resting position of the actuating member (7).

23. A switching system (1) according to claim 22, the switch lever (3) defines a switch plane (19) transverse to the movement direction of the switch lever (3), and wherein the switch lever (3) extends on the switch plane (19) when it is positioned in the first operating position,
wherein the switching from the first angular position to the second angular position occurs by means of a rotation of the actuating member (7) by a third angle (γ) with respect to the switch plane (19),
wherein the switching from the first angular position to the third angular position occurs by means of a rotation of the actuating member (7) by a fourth angle (δ) with respect to the switch plane (19),
and wherein the third angle (γ) is smaller than the fourth angle (δ).

24. A switching system (1) according to claim 22, configured so that, when the actuating member (7) is in the first angular position, the connecting mechanism (8) is configured to bias the switch lever (3) to the first operating position,
and wherein the resting position of the switching system (1) corresponds to the configuration in which the actuating lever (7) is in the first angular position, and the switch lever (3) is in the first operating position,
and, preferably, the first electric circuit (5) is configured to control a motorcycle speed adjustment function, and the second electric circuit (6) is configured to control a motorcycle engine start enabling function.

25. A switching system (1) according to claim 17, wherein the connecting mechanism (8) comprises a housing (15), preferably made of polybutylene terephthalate (PBT), which defines a first housing seat (16) open towards the actuating member (7),
wherein the connecting mechanism (8) comprises a guide piston (17) at least partially inserted into the first housing seat (16), wherein the guide piston (17) is translatable within the first housing seat (16), with respect to the housing (15),
wherein the guide piston (17) is connected to the switch lever (3) so that a translation of the guide piston (17) with respect to the housing (15) corresponds to a movement of the switch lever (3),
and wherein the connecting mechanism (8) comprises at least one elastic element (18) configured to bias the guide piston (17) into abutment against the actuating member (7).

26. A switching system (1) according to claim 25, wherein the elastic element (18) is interposed between the housing (15) and the guide piston (17), and is configured to bias the guide piston (17) to exit from the first housing seat (16),
wherein, preferably, the at least one elastic element (18) is a cylindrical compression coil spring, positioned substantially coaxial to the guide piston (17),
wherein the guide piston (17) comprises a thrust wall (20) abutting against the actuating member (7), and a rod (21) connected to the thrust wall (20), wherein the rod (21) extends from the thrust wall (20) in the opposite direction to the actuating member (7) and extends at least partially into the first housing seat (16),
wherein, optionally, the thrust wall (20) has a convex shape facing the actuating member (7), and/or the thrust wall (20) is shaped like a sphere portion and/or is shaped like a half-sphere, wherein the sphere portion wall abuts against the actuating member (7), and/or wherein the rod (21) is substantially cylindrical in shape, extending about an axis transverse to the switch plane (19),
and wherein the at least one elastic element (18) is interposed between the thrust wall (20) and the housing (15),
and optionally, the guide piston (17) is made of fiber-reinforced plastic and graphite.

27. A switching system (1) according to claim 25, wherein the guide piston (17) defines a coupling opening (22), and wherein the switch lever (3) is inserted into the coupling opening (22),
and, optionally, wherein the guide piston (17) comprises a thrust wall (20) abutting against the actuating member (7), and a rod (21) connected to the thrust wall (20), wherein the rod (21) extends from the thrust wall (20) in the opposite direction to the actuating member (7) and extends at least partially into the first housing seat (16), and wherein the coupling opening (22) passes through the rod (21) of the guide piston (17),
and/or the switch lever (3) extends through the coupling opening (22),
and/or a second end (12) of the switch lever (3) extends beyond the coupling opening (22),
and/or wherein the coupling opening (22) extends in a direction parallel to the rod (21), and the housing (15) defines a groove (25) facing the coupling opening (22) and open towards the actuating member (7).

28. A switching system (1) according to claim 27, configured so that:
when the actuating member (7) is in the first angular position, the coupling opening (22) is covered by the housing (15), and the switch lever (3) inserted into the coupling opening (22) is biased to the first operating position by means of the guide piston (17), and the switch lever (3) is not in contact with the at least one elastic element (18) interposed between the housing (15) and the guide piston (17);
when the actuating member (7) is in the second angular position, the coupling opening (22) is at least partially uncovered by the housing (15), and the switch lever (3) is in contact with the at least one elastic element (18), and the switch lever (3) inserted into the coupling opening (22) is biased to the second operating position by means of the biasing action of the at least one elastic element (18);
when the actuating member (7) is in the third angular position, the coupling opening (22) is at least partially uncovered, preferably totally uncovered, by the housing (15), and the switch lever (3) is in contact with the at least one elastic element (18), and the switch lever (3) inserted into the coupling opening (22) is biased to the third operating position by means of the biasing action of the at least one elastic element (18), and, preferably, in this configuration the at least one elastic element (18) is operatively maintained under compression by the switch lever (3) and the guide piston (17), so as to preserve an elastic bias against the switch lever (3) and the guide piston (17).

29. A switching system (1) according to claim 17, wherein the connecting mechanism (8) comprises an articulated connecting mechanism interposed between the actuating member (7) and the switch lever (3), configured to connect the actuating member (7) to the switch lever (3) so that a movement of the actuating member (7) corresponds to a movement of the switch lever (3),
or wherein the connecting mechanism (8) comprises a cam element interposed between the actuating member (7) and the switch lever (3), configured to connect the actuating member (7) to the switch lever (3) so that a movement of the actuating member (7) corresponds to a movement of the switch lever (3).

30. A switching system (1) according to claim 25, wherein the housing (15) defines a second housing seat (23), preferably open towards the actuating member (7), and wherein the switch body (4) is housed within the second housing seat (23).

31. A braking system (24), in particular for a motorcycle, moped or the like, comprising a brake lever operatively connected to a brake master cylinder, and further comprising a switching system (1) according to claim 17, and wherein the brake lever of the braking system (24) is the actuating member (7) of the switching system (1), and optionally, an actuating portion (10) of the actuating member (7) is a vane of a hub of the brake master cylinder of the braking system (24).

32. A clutch system, in particular for a motorcycle, moped or the like, comprising a clutch lever and a switching system (1) according to claim 17, and wherein the clutch lever of the clutch system is the actuating member (7) of the switching system (1).
